(19) United States
(12) Patent Application Publication
(10) Pub. No.: US 2025/0005570 A1
(43) Pub. Date: Jan. 2, 2025

(54) AUTOMATED AUTHENTICATION FOR SHIPMENT TRANSACTIONS

(71) Applicant: Relay Payments, Inc., Atlanta, GA (US)

(72) Inventors: James Ryan Droege, Atlanta, GA (US); Spencer Barkoff, Atlanta, GA (US); Giovanni Hobbins, Atlanta, GA (US)

(21) Appl. No.: 18/343,409

(22) Filed: Jun. 28, 2023

(51) Int. Cl. G06Q 20/40; G06Q 20/10

(52) U.S. Cl. CPC G06Q 20/40; G06Q 20/10

(57) ABSTRACT

An automated shipment transaction system is provided. The automated shipment transaction system automated various aspects of the shipment process involving brokers, carriers, shippers, etc. For example, the system may store profiles for various brokers and carriers (and/or other entities). When a carrier desires to onboard with a broker, the stored information may automatically be obtained to eliminate the need for the carrier to manually complete paperwork. At the completion of the shipment by the carrier, the carrier may be automatically paid by the system based on financial institution information stored for the broker. The system may verify that the correct carrier is picking-up a load and may also verify that the load is dropped-off at its destination using geo-fencing, for example. The system may also generate scores for entities, which may provide an indication of the quality of the entity. For example, a broker that provides timely payments to carriers may be provided a higher score than a broker that has missed several payments.

### BACKGROUND

Conventionally, the process for facilitating a shipment using a broker to connect a shipper and a carrier may be performed as follows. Initially, the carrier may need to be onboarded with a broker. This onboarding process typically involves the carrier manually completing paperwork to provide to the broker. Once the paperwork is completed and the carrier is onboarded, the broker may identify a shipper that requires a load for the carrier to transport based on the equipment owned by the carrier. For example, the number of trucks owned by the carrier, the size of the trucks, etc. The load to be assigned to the carrier may also be determined based on any other number of factors, such as an operating region of the carrier, preferences of the carrier, etc.

Once the shipper and the load are identified by the broker, the carrier may then proceed to obtain the load from the shipper and transport the load to a final destination. Upon reaching the final destination, the carrier may drop off the load to the recipient of the load. In order to receive payment, the carrier may be required to manually provide an invoice and proof of delivery (among other information) to the broker. This paperwork is reviewed by the broker and/or the shipper and the shipper may indicate to the broker that the delivery was properly completed. The shipper may then provide payment to the broker and the broker may provide payment to the carrier. This payment may be in the form of a check or the broker may alternatively manually obtain bank information for the carrier.

This process is often time-consuming and inefficient and may result compensation for the carrier to be delayed for a period of time after the delivery has been completed. Additionally, the carrier may often be responsible for paying for expenses during the transport of the load and may not be reimbursed by the broker for such expenses until several months after the shipment is completed. These manual processes are thus often detrimental to the carriers.

### BRIEF DESCRIPTION OF THE DRAWINGS

FIG. 1 is a system for automated shipment transactions, in accordance with one or more embodiments of the disclosure.

FIG. 2 is a flow diagram for facilitating an automated payment, in accordance with one or more embodiments of the disclosure.

FIG. 3A is a flow diagram for creating an entity profile, in accordance with one or more embodiments of the disclosure.

FIGS. 3B-3C are user interfaces for a dashboard, in accordance with one or more embodiments of the disclosure.

FIG. 4 is a flow diagram for generating a profile score, in accordance with one or more embodiments of the disclosure.

FIGS. 5A-5B are methods, in accordance with one or more embodiments of the disclosure.

FIG. 6 is an example computing device, in accordance with one or more embodiments of the disclosure.

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. The use of the same reference numerals indicates similar but not necessarily the same or identical components; different reference numerals may be used to identify similar components as well. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

### DETAILED DESCRIPTION

This disclosure relates to, among other things, systems and methods for automated authentication for shipment transactions. Particularly, systems and methods described herein automate various aspects of a shipment process, including transactions that occur between the various parties involved in the shipment process, such as payments and other financial transactions. For example, a shipment process may involve a shipper, a broker, and a carrier, among other parties. The shipper may be the entity that is supplying the goods to be shipped to the purchasing consumer (or any other destination for the goods). The carrier may be the entity that is transporting the goods from the shipper to the final destination (for example, a driver with a truck suitable to transport the goods). The broker may be the entity that facilitates finding a carrier to transport goods for the shipper or finding a shipper in need of a carrier for transporting a load (or simply identifying the load itself).

In contrast with the conventional manual approach to managing the shipment process, the systems and methods described herein instead automate various stages of the process to remove manual processes, decrease a likelihood of fraud, and increase transaction velocity. Beginning with the onboarding process, digital profiles may be created for the various entities involved in performing or facilitating shipments. For example, a broker may have an associated broker profile, a shipper may have an associated shipper profile, a carrier may have an associated carrier profile, etc. Any number of such profiles may exist for any number of different entities that are added to the system. For example, a first broker may have its own unique profile that includes information specific to the first broker and a second broker may also have its own profile that includes information specific to the second broker. These profiles may be stored within a database such that they may be accessed for use in future shipments and other types of transactions involving any of the different types of entities (as well as for any other purpose). That is, the database may serve as a repository for various entities involved in the shipment industry.

The different digital profiles may include identifying information associated with the various entities. For example, a carrier profile may include a name of the carrier, a mailing address for the carrier, contact information for the carrier, geographical regions served by the carrier (for example, a carrier may only service a particular region of a country or countries), equipment owned by the carrier (for example, a number of trucks, types of trucks, a volume of load capable of being transported by each truck, a number of drivers, etc.), bank account information, and/or any other information associated with the carrier. Any other type of identifying information may also be provided and stored in association with a profile for any of the different types of entities.

In some instances, this information may be manually provided by a user associated with the entity. For example, a carrier may access a website or application of the system and may manually input any of the identifying information into the website or application to create the digital profile for the carrier. Some or all of the information may also be automatically obtained by the system. For example, the user may provide some identifying information for the carrier (such as the name of the carrier entity) and the system may access a public database including information for the carrier to gather additional identifying information to include in the profile.

The system may also be configured to automatically verify any digital profiles that are being created to ensure that the digital profile is created by a user associated with the entity or otherwise authorized to create a profile for the entity. For example, during the profile creation process, the system may prompt the user to upload proof of ownership of the entity (or association with the entity). The system may compare this information to information included within a public database in which the entity is listed (for example, this may be the same database from which the system may automatically obtain identifying information about the entity, in some instances) to verify that the user creating the profile for the entity is actually associated with the entity. The verification may also be performed in any other suitable manner. If the system determines that the user attempting to create the profile is not verified, then the profile may not be generated and stored within the system. However, if the system determines that the user attempting to create the profile is verified, then the profile may be generated and stored within the system.

The profiles may also present different metrics based on prior shipments with which a particular entity was involved. For example, a carrier profile may indicate the number of shipments performed by the carrier, the percentage of deliveries performed on time, specific types of loads handled by the carrier, etc. A broker profile may include payment history for the broker (e.g., an indication of the timeliness of the broker in making payments to carriers), a number of shipments facilitated by the broker, etc.

Once a digital profile for an entity is created and stored within the database, the entity may no longer need to manually complete paperwork during the initial stages of a subsequent shipment. For example, once a profile for a carrier is established, if the carrier desires to onboard with a new broker, the requisite information may be automatically obtained from the database of the system by the broker system rather than the carrier needing to manually complete paperwork including the same information again for the new broker. In this manner, if a carrier desires to work with 10 different brokers, the carrier is not required to complete paperwork to onboard with all 10 of the brokers. Rather, the information from the carrier's digital profile may automatically be obtained and transmitted the 10 different brokers. Alternatively, the onboarding process may be facilitated through the system rather than requiring the onboarding to be performed through independent broker systems.

The profiles for the various entities may also be used to automate aspects of the shipment process beyond the initial onboarding of a carrier with a broker as well. For example, once a load has been delivered to a final destination by a carrier, the system may automatically facilitate payment between the broker and the carrier (and/or payment between the shipper and the broker). The system may obtain information about the financial institution(s) for the broker and the carrier through the profile for the broker and the profile for the carrier stored in the database of the system to facilitate the payment to the carrier. Thus, the carrier may be compensated instantaneously or otherwise sooner than would be the case if the carrier were required to manually prepare an invoice to submit to the broker to receive compensation.

In the conventional shipment process, the potential also exists for a fraudulent carrier to obtain a load from the shipper rather than the correct carrier. This may occur for a number of reasons, such as the lack of effective systems for verifying that the carrier attempting to pick-up the load is the correct carrier, among other reasons. To verify that the load pick-up (e.g., the carrier obtains the load from the shipper) and drop-off portions (e.g., the carrier delivers the load to the final destination) of the shipment process are correctly performed and performed by the correct carrier, the system may also include additional verification mechanisms at these stages of the shipment process. For example, at the pick-up stage, the system may determine if a known device of the carrier is within a threshold distance (e.g., a geo-fence) of the pick-up location for the load. If the carrier device is within the threshold distance, then the system may provide authorization for the carrier to obtain the load to perform the shipment. For example, an indication of authorization may be transmitted to a device of the shipper such that the shipper may view the authorization.

However, if the carrier device is not within the threshold distance, then the system may indicate that the carrier attempting to obtain the load is unauthorized to obtain the load from the shipper. The verification that the carrier attempting to obtain the load is the correct carrier may also be performed in any other suitable manner. For example, a unique digital token may be provided to the carrier device and the token may be verified by the system through the shipper when the carrier arrives at the shipper's facility. As another example, the load may be secured within a location using an automated locking mechanism that may automatically unlock when it is determined that the carrier device is within the threshold distance.

Likewise, a similar verification mechanism may be used to determine when the carrier has arrived at the delivery destination and delivered the load. That is, the system may determine if the carrier device is within a threshold distance of the delivery destination. The threshold distance may be pre-established by any of the entities involved in the shipment process and/or may be a fixed value regardless of the entities involved. The threshold distance may also, in some cases, be based on the size of the facility of the shipper at which the load is received. For example, the threshold distance may be a smaller value if the facility is smaller in size.

The system may also require further conditions to be satisfied for the carrier to be provided the load for transport. For example, an indication may be provided by the recipient of the load that the load has been delivered by the carrier. Based on one or more of these conditions (and/or any other conditions) being satisfied, the system may automatically initiate the payment transaction between the broker and the carrier. In some instances, all of the conditions may need to be satisfied.

In one or more embodiments, any of the digital profiles included within the system may also automatically be provided a score (also referred to herein as an “authentication score”) by the system using a score-generating algorithm. The score may provide a quantitative assessment entity associated with the digital profile (e.g., a trustworthiness of the entity). For example, a score may be a numerical value with a lower numerical value indicating that the entity is less desirable to work with. However, the scores may be provided in any other format as well, numerical or otherwise.

The score may be automatically generated based on historical data associated with the entity. For example, a score for a broker may be automatically generated based on the timeliness of payments to carriers by the broker. Similarly, the score may also be based on a credit history of the entity. As another example, a score for a carrier may be automatically generated based on historical delivery timeliness for the carrier.

The score may also be generated based on factors relating to the entity itself and the operation of the entity. For example, the score may be based on the size of the entity (e.g., number of employees, number of locations, number of equipment owned by the entity, revenue generated per year by the entity, etc.). As another example, the score may be based on a length of time that the entity has existed.

The score may also be generated based on user reviews of the entity. For example, a particular broker may include several carrier reviews indicating that the broker is slow to respond to communications. Thus, this broker may be provided a lower score than a broker that receives positive reviews. In some instances, it may be determined whether an average user feedback value associated with the entity is greater than a threshold value.

The scores may also be based on the digital profiles themselves. For example, the scores may be based on a completeness of the digital profile (e.g., the amount of information that is provided). The scores may also be based on whether or not a contact number or other contact information for the entity is provided in the digital profile. These are just examples of factors that are considered by the algorithm in generation of the scores and the scores may also be generated using any other factors.

These scores may be used by the system for various purposes. For example, authorization (the term “authenticated” may also be used herein) may be required before a payment is facilitated between a broker and a carrier for a shipment performed by the carrier on behalf of a shipper connected with the carrier through the broker. In some instances, depending on the score associated with the particular broker, the payment may be automatically authorized by the system. For example, if the score is a numerical value with a larger score indicating a more desirable broker, then the payment may automatically be authorized by the system if the score for the broker is greater than or equal to a threshold score. Otherwise, manually authorization by the broker or otherwise may need to be performed for the payment to be processed.

Additionally, the scores may be presented as part of profiles viewable through the dashboard associated with the system. That is, a carrier seeking a broker to assist the carrier in locating shippers with loads for shipment may be able to view the scores associated with various brokers with profiles stored within the system. This allows the carrier to obtain information about the broker and past transactions the broker was involved with to determine if the carrier desires to interact with the broker. For example, if the scores range from numerical values of 1 to 10 and a first broker has a score of 3 and a second broker has a score of 9, then a carrier may view this information and determine that the second broker is likely more desirable to engage with in a shipment transaction than the first broker. This likewise may be applicable from the broker's perspective when determining if they desire to engage with a particular carrier to connect with a shipper to perform a load shipment.

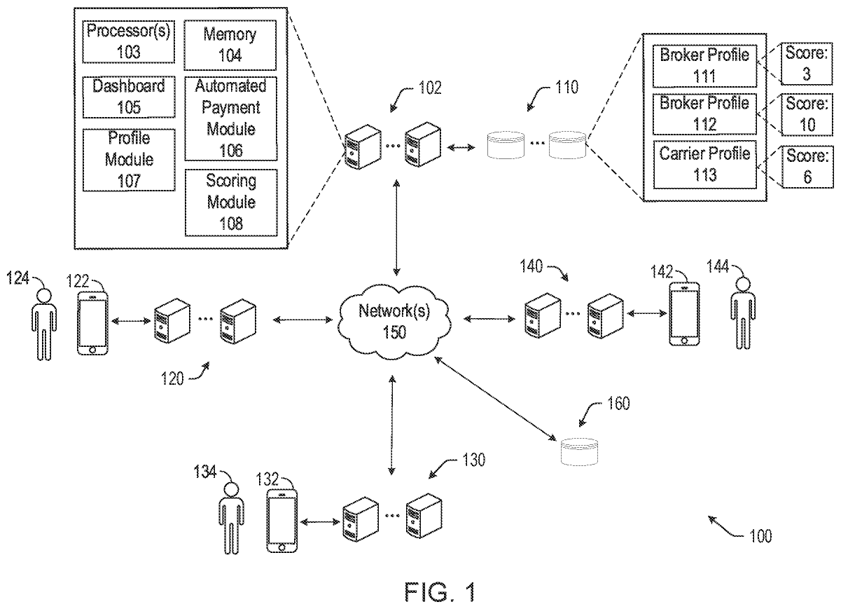

Turning to the figures, FIG. 1 illustrates an example of a system 100, in accordance with one or more embodiments of this disclosure. In one or more embodiments, the system 100 may include at least one or more computing devices 102 (which may be associated with the automated transaction system as described herein), one or more databases 110 and 160, one or more broker devices 120, one or more carrier devices 130, and/or one or more supplier devices 140. The devices of the system 100 may be associated with various entities involved in facilitating a shipment process. For example, the one or more broker devices 120 may be associated with a broker entity, the one or more carrier devices 130 may be associated with a carrier entity, the one or more supplier devices 140 may be associated with a supplier entity, etc. For simplicity, reference may be made herein to a singular “database,” “device,” “system,” etc. However, this is not intended to be limiting and any other number of such components may also be applicable.

In one or more embodiments, users associated with the various entities (for example, user 124 associated with the broker entity, user 134 associated with the carrier entity, and user 144 associated with the supplier entity) may interact with any of the one or more computing devices 102, one or more broker devices 120, one or more carrier devices 130, and/or one or more supplier devices 140 through one or more user devices (for example, user device 122, user device 132, and/or user device 142). The user device may include any type of device, such as a smartphone, a laptop or desktop computer, a tablet, a smart television, etc. An application may be provided on a user device that allows a user to perform functions, such as, for example, generating a digital profile for an entity, communicating with other user devices of other entities, viewing digital profiles of other entities (for example, through the dashboard 105), facilitating a shipment process, including payments, etc.

The computing device 102 may facilitate the primary functions of the automated shipment transaction system as described herein. That is, any of the entity profile creation and presentation, automated payment processing, entity scoring, and/or any other functionality described herein may be performed by the computing system 102 (however, in some cases, some or all of the processing may also be performed by any other device or system, such as broker device 120, carrier device 130, shipper device 140, user devices, etc.). To facilitate this functionality, the computing system 102 may include a number of different software modules. For example, an automated payment module 107, a profile module 107, a scoring module 108, and/or any other combination of different types of modules. In some instances, a single software module may be used to perform any of the functionality.

The automated payment module 106 may facilitate automated payments between brokers and carriers (and/or any other entities involved in a transactions to pay a carrier after dropping-off a load at a destination. Using an example in which the carrier performs a shipment for the shipper through the broker, the carrier may conventionally be required to provide an invoice to the broker along with various other paperwork (including bank account information). The broker may then need to process the paperwork before providing a check to the carrier or depositing the payment in the bank account for the carrier. This process may also require interactions between the broker and shipper (and/or other entities involved in the shipment process). This results in a delay between the completion of the shipment by the carrier and the payment being received by the carrier.

In contrast, using the computing device 102, once it has been determined that the carrier has completed a shipment for the shipper through the broker, either the computing device 102 or the broker device 120 (and/or the shipper device 140) may access a broker profile 111 and a carrier profile 113 (and/or a profile for the shipper) to obtain bank information to facilitate the payment to the carrier for completing the shipment. This allows the carrier to receive payment instantaneously or at a significantly quicker rate than if the payment is manually processed (which could take up to months to perform manually).

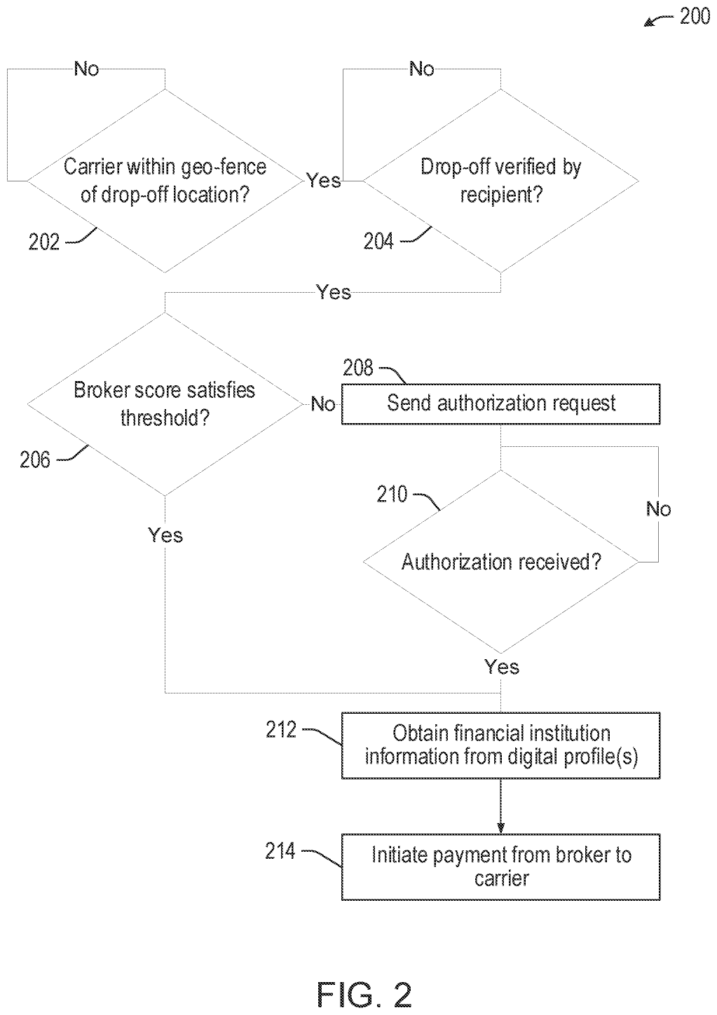

FIG. 2 is a flow diagram 200 for facilitating an automated payment (for example, as performed by the automated payment module 106), in accordance with one or more embodiments of the disclosure. The flow diagram 200 provides additional details regarding operations performed to automatically facilitate a payment transaction between a broker and a carrier upon completion of a delivery by the carrier.

Condition 202 involves determining if the carrier is within a geo-fence of the drop-off location. To determine when the carrier has performed the drop-off of the load at the designated destination location, a geo-fence may be used. For example, if the user 134 is a delivery driver for the carrier, the location of the user device 132 may be tracked. It may be determined that the user 134 has completed the delivery once the user device 132 is identified as being within the designated geo-fence at the delivery destination (for example, using global positioning system (GPS) and/or any other suitable tracking mechanism). If condition 202 is satisfied, the flow diagram 200 proceeds to condition 204. Otherwise, the flow diagram 200 loops condition 202 until condition 202 is satisfied.

Condition 204 involves determining if the drop-off is verified by the recipient. In some instances, further conditions may be required to be satisfied in addition to the user device 132 being within the geo-fence as well. For example, an entity accepting delivery of the load from the user 134 may need to provide an indication that the delivery was completed (for example, through another user device of the entity receiving the delivery). Any other conditions may also be applied as well. In some embodiments, once the requisite conditions are satisfied, the computing device 102 may initiate the automated payment to the carrier. In such cases, the flow diagram 200 may proceed directly to operation 212.

In some embodiments, however, authorization may also be required before a payment is facilitated between the broker and/or shipper and the carrier. Thus, if condition 204 is satisfied, then the flow diagram 200 may proceed to condition 206. Condition 206 may involve determining if the broker score (e.g., the score generated for the digital profile of the broker) satisfies a threshold. In some instances, depending on the score associated with the particular broker, the payment may be automatically authorized by the system. For example, if the score is a numerical value with a larger score indicating a more desirable broker, then the payment may automatically be authorized by the system if the score for the broker is greater than or equal to a threshold score. That is, if condition 206 is satisfied, then the flow diagram 200 may proceed to operation 212. Otherwise, the flow diagram 200 may proceed to operation 208 and manual authorization by the broker or otherwise may need to be performed for the payment to be processed.

Operation 208 involves sending an authorization request to the broker (and/or any other entity involved in the transaction) to authorize the payment. For example, the authorization request may be sent from the computing device 102 to the broker device 120 and/or the user device 122. Condition 210 involves determining if authorization is received. For example, user 132 may provide an indication of authorization for the payment through the user device 122 and/or the broker device 120. The authorization may then be transmitted to the computing device 102. In the case of FIG. 1, if the threshold score is 7, then the first broker may be required to manually provide authorization since the score in the broker profile 111 is 3. However, if the second broker were involved in the transaction, then the payment would automatically be authorized given that the broker profile 112 is associated with the score of 10. Once condition 210 is satisfied, the flow diagram 200 may proceed to operation 212.

Operation 212 involves obtaining financial institution information from the digital profile(s). That is, any bank information for the broker, carrier, etc. that is secured stored on the digital profiles may be obtained to facilitate the payment transaction. Finally, operation 214 involves initiating the payment from the broker to the carrier. Payment may also be facilitated between the shipper and the broker before the transaction between the broker and carrier.

Another aspect of the payment process is payment for expenses incurred as the carrier transports the load to the destination (for example, fuel for the truck, tolls, parking fees, etc.). Conventionally, the carrier may be required to front such expenses and may be required to submit additional manual paperwork upon completion of the delivery to obtain reimbursement for certain expenses. This process, however, may take up to several months before the carrier is reimbursed. Instead, the computing device 102 may generate a token that may be used by the user 134 to facilitate payment for expenses on behalf of the broker and/or the shipper, rather than the user 134 paying out-of-pocket. The token may be provided to the user 134 in any manner. For example, a token may be transmitted from the computing device 102 to the user device 132, a token may be printed and provided to the user 134, etc.

The database 100 may be used to store any of the data used by the computing device 102 and/or any of the other devices in the system 100 to process a given shipment process. For example, FIG. 1 shows that the database 100 may store various entity profiles, such as broker profile 111, broker profile 112, and carrier profile 113. Broker profile 111 may be a profile for a first broker entity and broker profile 112 may be a profile for a second broker entity. Any other number of profiles may exist for any other number of different types of entities as well.

The profiles may include identifying information associated with the various entities. For example, the carrier profile 113 may be created for the carrier associated with carrier device 130. The carrier profile 113 may include a name of the carrier, a mailing address for the carrier, contact information for the carrier, geographical regions served by the carrier (for example, a carrier may only service a particular region of a country or countries), equipment owned by the carrier (for example, a number of trucks, types of trucks, a volume of load capable of being transported by each truck, a number of drivers, etc.), bank account information, and/or any other information associated with the carrier. Any other type of identifying information may also be provided and stored in association with a profile for any of the different types of entities. For example, similar types of data may be stored for the broker profile 111 and the broker profile 112 as well.

The profiles may also present different metrics based on prior shipments with which a particular entity was involved. For example, the carrier profile 113 may indicate a number of shipments performed by the carrier, a percentage of deliveries performed on time, specific types of loads handled by the carrier, etc. The broker profile 111 may include payment history for the broker (e.g., an indication of the timeliness of the broker in making payments to carriers), a number of shipments facilitated by the broker, etc.

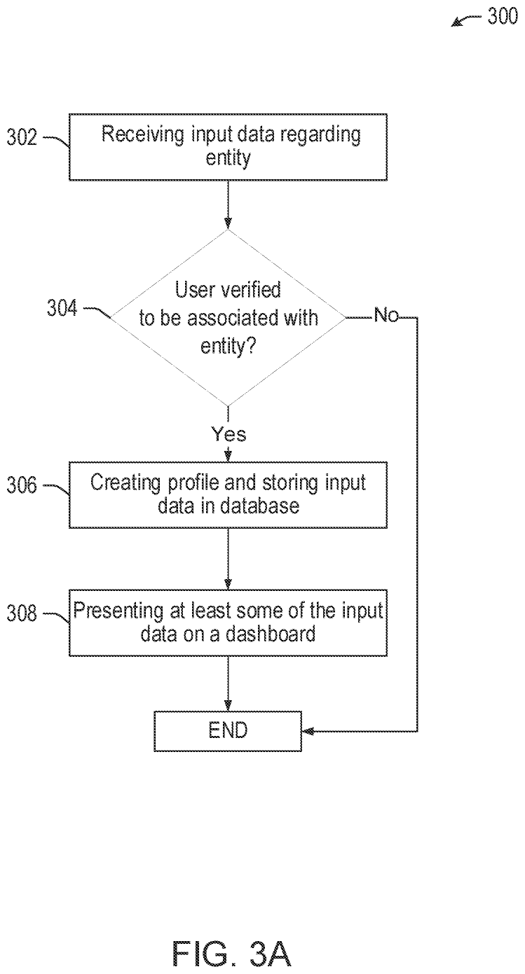

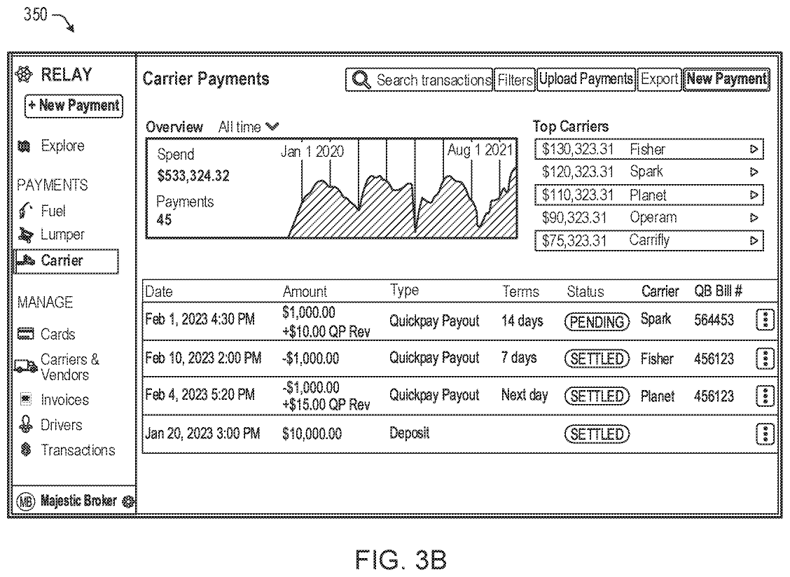

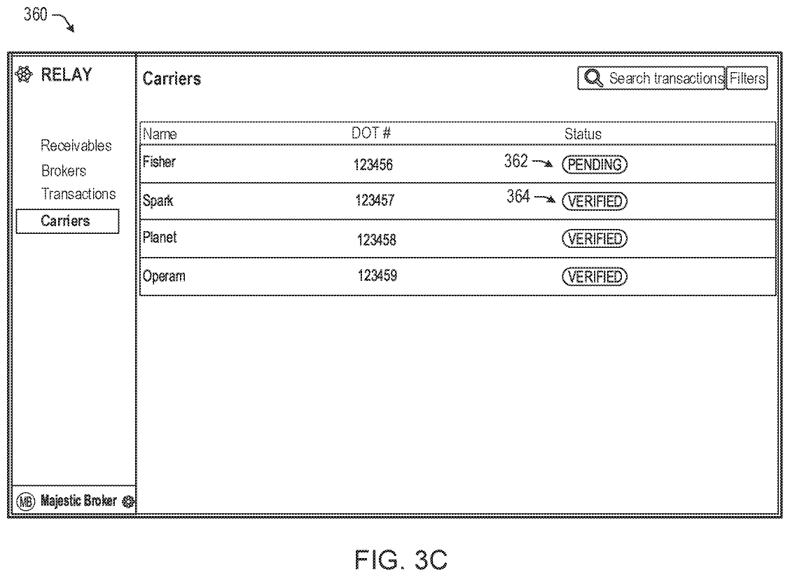

Turning to FIG. 3A, a flow diagram 300 for creating an entity profile is shown. In some cases, the operations of the flow diagram 200 may be performed using the profile module 107. Operation 302 may involve receiving input data (also referred to herein as “identifying information”) regarding an entity (for example, a broker, carrier, shipper, etc.). This data may be manually provided by a user associated with the entity. For example, the user 134 may access a website or application through the user device 132 and may manually input any of the identifying information into the website or application to create the carrier profile 113. However, in some instances, some or all of the information may also be automatically obtained by the computing device 102. For example, the user 134 may provide some identifying information for the carrier (such as the name of the carrier entity) and the computing device 102 may access a public database including information for the carrier to gather additional identifying information to include in the profile.

Condition 304 may involve determining whether the user is verified to be associated with the entity. The computing device 102 may also be configured to automatically verify any profiles that are being created to ensure that the profile is created by a user associated with the entity or otherwise authorized to create a profile for the entity. For example, during the profile creation process for the carrier profile 113, the computing device 102 may prompt the user 134 to upload proof of ownership of the entity (or association with the entity) to the computing device 102 using the user device 132. The computing device 102 may compare this information to information included within a public database (for example, database 160) in which the entity is listed (for example, this may be the same database from which the computing device 102 may automatically obtain identifying information about the carrier, in some instances) to verify that the user 134 creating the profile for the carrier is actually associated with the carrier.

Verification may also be performed in any other suitable manner. As further examples, an entity may be prompted to upload a voided check for verification. The entity may also be called or contacted in another manner to perform verification. Similar verification may also be performed for the creation of the broker profiles 111 and 112, as well as any other profiles that are created. If the user is verified to be associated with the entity, then the flow diagram 300 proceeds to operation 306. Otherwise, the profile creation process is ended and the profile is not created for the entity.

Operation 306 involves creating the profile for the entity and storing the profile and the input data within a database (for example, database 110).

Operation 308 may involve presenting at least some of the input data on a dashboard (for example, dashboard 105). The computing device 102 may also include a dashboard 105 that may be presented via a user interface that is accessible by any of the user devices 122, 132, 142. For example, the users 124, 134, and 144 may view the dashboard through a website or application user interface. The dashboard 105 may allow a user to view at least some of the information in the various profiles 110 stored in the database. For example, user 134 may be able to view contact information for the first broker through broker profile 111 (but may not be able to view bank information). The dashboard 105 may also allow users to view any scores associated with the various entities represented by the profiles in the database 110.

FIGS. 3B-3C are a user interfaces 350 and 360 for a digital profile dashboard, in accordance with one or more embodiments of the disclosure. Particularly, the user interface 350 depicts an example dashboard for a broker profile. The user interface 350 provides information that is specific to that particular broker, such as recent transactions and other metrics. The user interface 350 also allows the broker to initiate a new payment (for example, to a carrier and/or perform any other functionality.

The user interface 360 also illustrates that some or all of the entities presented on the dashboard may be verified entities. For example, FIG. 3C shows a first verification status 362 of “pending” for a first carrier and a second verification status 364 of “verified” for a second carrier.

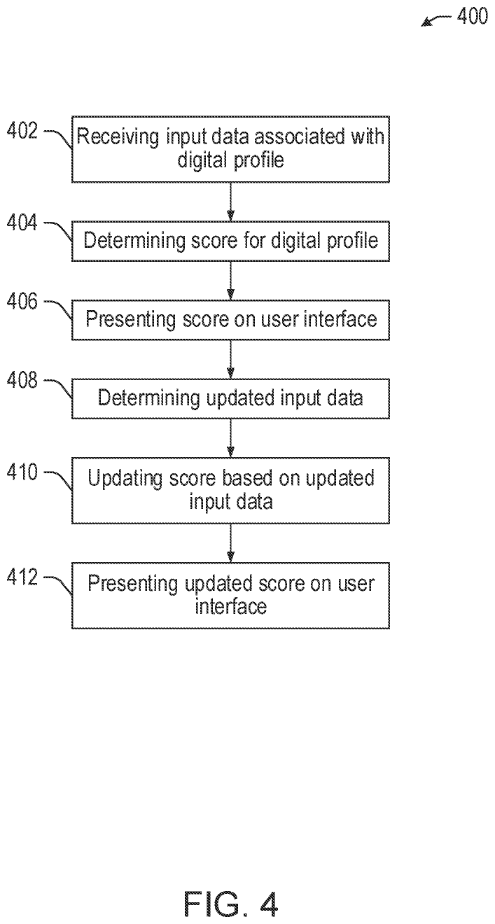

FIG. 4 is a flow diagram 400 for generating a digital profile score, in accordance with one or more embodiments of the disclosure. In some cases, the operations of the flow diagram 200 may be performed using the scoring module 108.

Operation 402 may involve receiving input data associated with a digital profile. For example, the input data may include the identifying information provided during creation of the digital profile. The input data may also include metrics associated with the entity. For example, a carrier profile may indicate the number of shipments performed by the carrier, the percentage of deliveries performed on time, specific types of loads handled by the carrier, etc. A broker profile may include payment history for the broker (e.g., an indication of the timeliness of the broker in making payments to carriers), a number of shipments facilitated by the broker, etc. The input data may also include user reviews from users and/or entities that previously worked with the entity being scored. The input data may also include any other types of data.

Operation 404 may involve determining a score for the digital profile. Any of the profiles included within the database 110 may also automatically be provided a score by the computing device 102 (for example, by the scoring module 108). The score may provide a quantitative evaluation of the entity. The score may be automatically generated based on any number of factors described herein or otherwise. For example, a score for a broker may be automatically generated based on the timeliness of payments to carriers by the broker. As another example, a score for a carrier may be automatically generated based on historical delivery timeliness for the carrier. As a further example, the score may be generated based on whether user reviews of the entity are positive or negative. For example, a larger number of negative reviews may result in a lower score being generated for the digital profile of the entity. Any of these (and any other) factors may also be considered in combination when determining the score. Additionally, some factors may be provided greater weight over others when determining the score. These are just examples of factors that may be used to generate the scores and any other factors and/or combination of factors provided any weighting may also be used. Operation 406 may involve presenting the score on a user interface (for example, the dashboard 105).

As shown in FIG. 1, the scores may be numerical values that range between 1-10, with a lower score providing an indication that the entity associated with the profile is less desirable to work with For example, the broker profile 111 indicates that the first broker was provided a score of 3, the broker profile 112 indicates that the second broker was provided a score of 10, and the carrier profile 113 indicates that the carrier was provided a score of 6. The score of 3 for the broker profile 111 and the score of 10 for the broker profile 112 may indicate to the computing device 102 that the first broker 111 is more desirable to work with than the second broker 112. The relative scores may also provide any other types of information to the computing device 102, such as the ability of the broker to provide timely payments to other entities involved in the transaction. Although the scores are shown as numerical values within a particular range in FIG. 1, this is merely illustrative and the scores may be provided in any other range of numerical values or any other form as well.

Operation 408 may involve determining updated input data. Operation 410 may involve updating the score based on the updated input data. That is, the scores may not necessarily be fixed and may be updated periodically (or in real-time) by the computing device 102 as additional data regarding the different entities if obtained. For example, although the broker profile 112 is shown as being associated with a score of 10, the computing device 102 may update the broker profile 112 to a score of 9 if it is determined that the second broker was late on a series of payments to a carrier. As another example, the score associated with the broker profile 112 may be lowered if the second broker receives more than a threshold number of negative reviews from users (for example, on the dashboard 105 or any other website). Finally, operation 412 may involve presenting the updated score on the user interface.

Returning to FIG. 1, the broker device 120, carrier device 130, and shipper device 140 (and/or any other device associated with any other entity involved in a shipment process) may be devices of the various entities that are distinct from the computing device 102. For example, the devices may be servers that host software used by the entities or store data used by the entities. For example, during an onboarding process, the computing device 102 may provide information about a carrier from the carrier profile 113 to the broker device 120 and the onboarding may be performed using the broker device 120 (that is, the computing device 102 may facilitate the automated onboarding, but the onboarding may be performed at the broker device 120). However, in other instances, all of the processing and data storage involved in the shipment process may be performed at the computing device 102 and the entity devices may not necessarily be required.

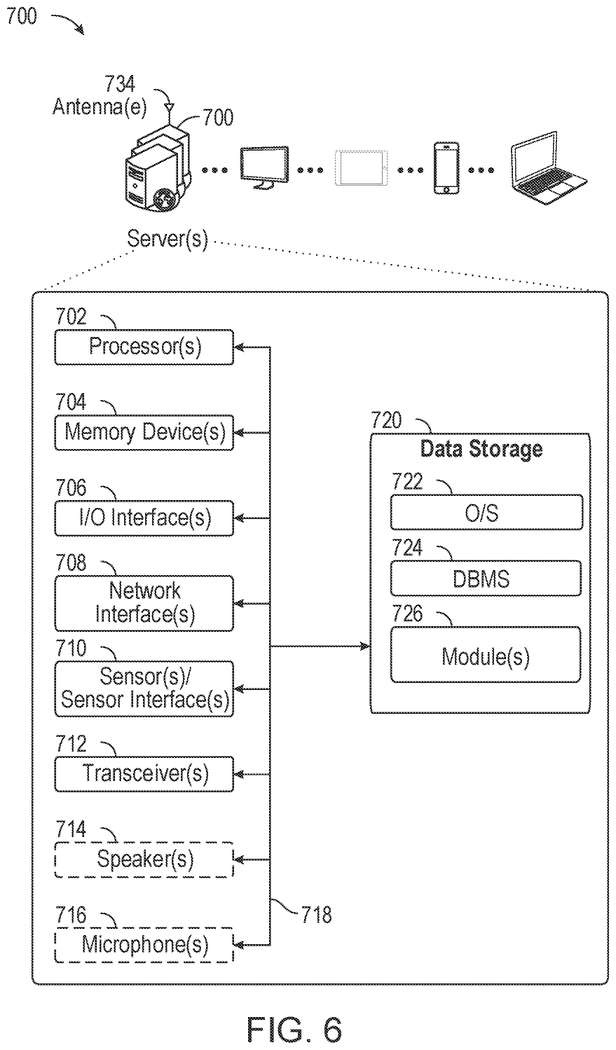

Any of the elements of the system, such as the one or more computing devices, one or more databases 110 and 160, one or more broker devices 120, one or more carrier devices 130, one or more supplier devices 140, and/or one or more user devices may perform communications via a communications network 150. The communications network 150 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Additional details about example communications networks may be described with respect to FIG. 6 as well.

Further, any of the elements of the system of may include any of the components of the computing device(s) 600 described with respect to FIG. 6. That is, although the figure may only depict a particular element of system 100 as having one or more processors, memory, and one or more modules (for example, only computing device 102 is shown as including such elements), this is not intended to be limiting in any way.

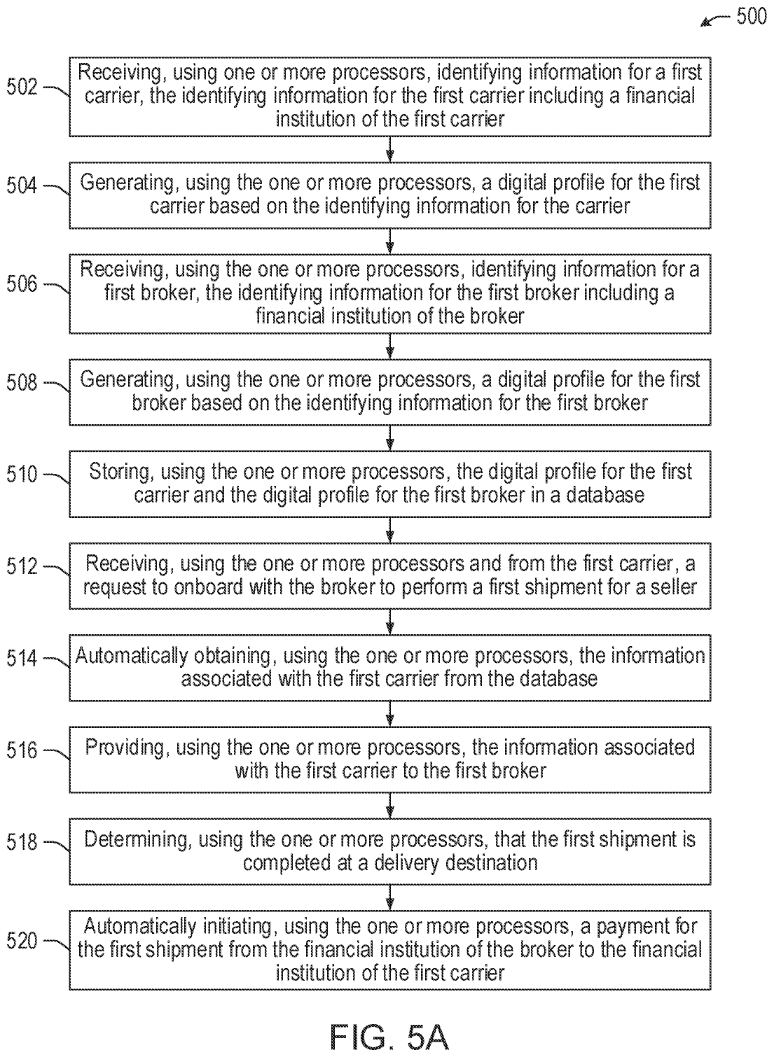

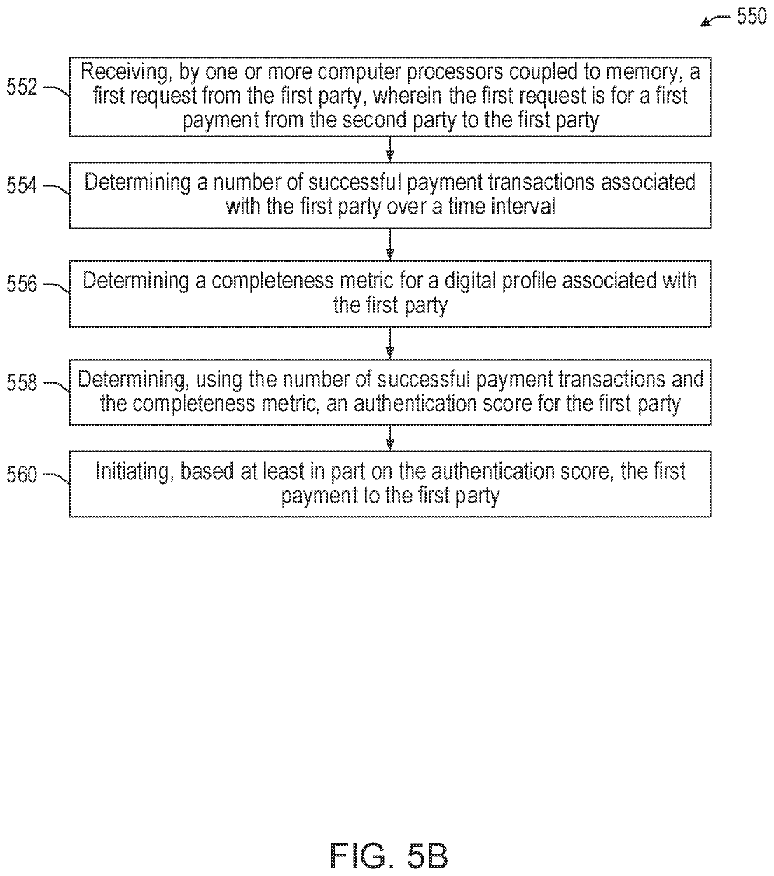

FIG. 5A is an example method 500, in accordance with one or more embodiments of the disclosure. The method 500 may be performed by any of the systems or devices described herein (for example, computing device 102, broker device 120, carrier device 130, shipper device 140, users devices 122, 132, 142, computing device 600, and/or any other device and/or system described herein or otherwise).

At block 502, the method 500 may include receiving, using one or more processors, identifying information for a first carrier, the identifying information for the first carrier including a financial institution of the first carrier. The identifying information may also include any other information described herein or otherwise, such as contact information for the first carrier, a geographic region served by the first carrier, equipment owned by the first carrier (e.g., number of trucks, sizes of trucks, etc.), a number of delivery drivers, and/or any other information.

At block 504, the method 500 may include generating, using the one or more processors, a digital profile for the first carrier based on the identifying information for the carrier. For example, the digital profile for the first carrier may be similar to the carrier profile 113 shown in FIG. 1.

At block 506, the method 500 may include receiving, using the one or more processors, identifying information for a first broker, the identifying information for the first broker including a financial institution of the first broker. Similar to the identifying information for the first carrier, the identifying information for the first broker may also include any other types of information. For example, contact information for the first broker and/or any other types of information.

At block 508, the method 500 may include generating, using the one or more processors, a digital profile for the first broker based on the identifying information for the first broker. For example, the digital profile for the first broker may be similar to the broker profile 111 or 112 of FIG. 1.

At block 510, the method 500 may storing, using the one or more processors, the digital profile for the first carrier and the digital profile for the first broker in a database. The digital profile may be stored within a database, such that at least some of the information included within the profile may be accessible for subsequent use. However, some of the information may be securely stored, such that only users with permissions are able to access the information (e.g., bank account information).

At block 512, the method 500 may include receiving, using the one or more processors and from the first carrier, a request to onboard with the broker to perform a first shipment for a seller. At block 514, the method 500 may automatically obtaining, using the one or more processors, the information associated with the first carrier from the database. At block 516, the method 500 may providing, using the one or more processors, the information associated with the first carrier to the first broker. The first carrier may determine that they desire to work with the first broker so that the first broker can identify a seller that required a load to be transported. Conventionally, this onboarding process may involve the first carrier manually completing time-consuming paperwork, among other manual tasks. However, with the identifying information for the first carrier and the first broker being stored in the digital profile for the first carrier and the digital profile for the first broker, respectively, this information may be automatically obtained from the database to facilitate the onboarding between the broker and the carrier. For example, broker device 120 may obtain the information from database 110 (in FIG. 1). Alternatively, computing device 102 may perform the onboarding or may transmit the information to the broker device 120 from the database 110.

At block 518, the method 500 may include determining, using the one or more processors, that the first shipment is completed at a delivery destination. At block 520, the method 500 may automatically initiating, using the one or more processors, a payment for the first shipment from the financial institution of the broker to the financial institution of the first carrier.

FIG. 5B is an example method 550, in accordance with one or more embodiments of the disclosure. The method 550 may also be performed by any of the systems or devices described herein (for example, computing device 102, broker device 120, carrier device 130, shipper device 140, users devices 122, 132, 142, computing device 600, and/or any other device and/or system described herein or otherwise).

At block 552, the method 500 may include receiving, by one or more computer processors coupled to memory, a first request from the first party, wherein the first request is for a first payment from the second party to the first party. For example, the second party may be a broker and the first party may be a carrier, and the first payment may be payment from the broker to the carrier upon completion of a shipment performed by the carrier. However, the first payment may also be associated with any other entities as well.

At block 554, the method 500 may include determining a number of successful payment transactions associated with the first party over a time interval. At block 556, the method 500 may include determining a completeness metric for a digital profile associated with the first party. At block 558, the method 500 may include determining, using the number of successful payment transactions and the completeness metric, an authentication score for the first party. The authentication score may also be determined based on any other number of factors described herein or otherwise. For example, the authentication score may be based on a determination that a contact number associated with the first party is valid or determining that an average feedback value associated with the first party is greater than a threshold.

At block 560, the method 500 may include initiating, based at least in part on the authentication score, the first payment to the first party. The first payment may be performed using a third party bank account that is not associated with the second party, for example. Additionally, the third party bank account information may be obtained from a digital profile associated with the first party or a digital profile associated with the second party.

In some instances, if the authentication score fails to satisfy a threshold value, then a request for authentication may be sent to the first party (for example, a device of the first party). In this manner, a manual indication of authentication may be required from the first party before the payment is initiated. For example, if the authentication score falls below a threshold value, this may indicate that the second party is untrustworthy and automated authentication may not be performed. In some instances, the authentication request may also be sent to the second party (or to both the first party and the second party).

The operations described and depicted in the illustrative methods, process flows, and use cases of FIGS. 2-5B may be carried out or performed in any suitable order, such as the depicted orders, as desired in various example embodiments of the disclosure. Additionally, in certain example embodiments, at least a portion of the operations may be carried out in parallel. Furthermore, in certain example embodiments, less, more, or different operations than those depicted in FIGS. 2-5B may be performed.

FIG. 6 is a schematic block diagram of one or more illustrative computing device(s) 600 in accordance with one or more example embodiments of the disclosure. The computing device(s) 600 may include any suitable computing device including, but not limited to, a server system, a mobile device such as a smartphone, a tablet, an e-reader, a wearable device, or the like; a desktop computer; a laptop computer; a content streaming device; a set-top box; or the like. The computing device(s) 600 may correspond to an illustrative device configuration for any of the computing systems described herein and/or any other system and/or device.

The computing device(s) 600 may be configured to communicate via one or more networks. Such network(s) may include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. Further, such network(s) may have any suitable communication range associated therewith and may include, for example, global networks (e.g., the Internet), metropolitan area networks (MANs), wide area networks (WANs), local area networks (LANs), or personal area networks (PANs). In addition, such network(s) may include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof.

In an illustrative configuration, the computing device(s) 600 may include one or more processors (processor(s)) 602, one or more memory devices 604 (generically referred to herein as memory 604), one or more input/output (I/O) interfaces 606, one or more network interfaces 608, one or more sensors or sensor interfaces 610, one or more transceivers 612, one or more optional speakers 614, one or more optional microphones 616, and data storage 620. The computing device(s) 600 may further include one or more buses 618 that functionally couple various components of the computing device(s) 600. The computing device(s) 600 may further include one or more antenna(s) 634 that may include, without limitation, a cellular antenna for transmitting or receiving signals to/from a cellular network infrastructure, an antenna for transmitting or receiving Wi-Fi signals to/from an access point (AP), a Global Navigation Satellite System (GNSS) antenna for receiving GNSS signals from a GNSS satellite, a Bluetooth antenna for transmitting or receiving Bluetooth signals, a Near Field Communication (NFC) antenna for transmitting or receiving NFC signals, and so forth. These various components will be described in more detail hereinafter.

The bus(es) 618 may include at least one of a system bus, a memory bus, an address bus, or a message bus, and may permit the exchange of information (e.g., data (including computer-executable code), signaling, etc.) between various components of the computing device(s) 600. The bus(es) 618 may include, without limitation, a memory bus or a memory controller, a peripheral bus, an accelerated graphics port, and so forth. The bus(es) 618 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnect (PCI) architecture, a PCI-Express architecture, a Personal Computer Memory Card International Association (PCMCIA) architecture, a Universal Serial Bus (USB) architecture, and so forth.

The memory 604 of the computing device(s) 600 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. Persistent data storage, as that term is used herein, may include non-volatile memory. In certain example embodiments, volatile memory may enable faster read/write access than non-volatile memory. However, in certain other example embodiments, certain types of non-volatile memory (e.g., FRAM) may enable faster read/write access than certain types of volatile memory.

In various implementations, the memory 604 may include multiple different types of memory such as various types of static random access memory (SRAM), various types of dynamic random access memory (DRAM), various types of unalterable ROM, and/or writeable variants of ROM such as electrically erasable programmable read-only memory (EEPROM), flash memory, and so forth. The memory 604 may include main memory as well as various forms of cache memory such as instruction cache(s), data cache(s), translation lookaside buffer(s) (TLBs), and so forth. Further, cache memory such as a data cache may be a multi-level cache organized as a hierarchy of one or more cache levels (L1, L2, etc.).

The data storage 620 may include removable storage and/or non-removable storage, including, but not limited to, magnetic storage, optical disk storage, and/or tape storage. The data storage 620 may provide non-volatile storage of computer-executable instructions and other data. The memory 604 and the data storage 620, removable and/or non-removable, are examples of computer-readable storage media (CRSM) as that term is used herein.

The data storage 620 may store computer-executable code, instructions, or the like that may be loadable into the memory 604 and executable by the processor(s) 602 to cause the processor(s) 602 to perform or initiate various operations. The data storage 620 may additionally store data that may be copied to the memory 604 for use by the processor(s) 602 during the execution of the computer-executable instructions. Moreover, output data generated as a result of execution of the computer-executable instructions by the processor(s) 602 may be stored initially in the memory 604, and may ultimately be copied to the data storage 620 for non-volatile storage.

More specifically, the data storage 620 may store one or more operating systems (O/S) 622; one or more database management systems (DBMSs) 624; and one or more program module(s), applications, engines, computer-executable code, scripts, or the like such as, for example, one or more module(s) 626 (for example, automated payment module 107, a profile module 107, a scoring module 108, and/or any other combination of different types of modules). Some or all of these module(s) may be sub-module(s). Any of the components depicted as being stored in the data storage 620 may include any combination of software, firmware, and/or hardware. The software and/or firmware may include computer-executable code, instructions, or the like that may be loaded into the memory 604 for execution by one or more of the processor(s) 602. Any of the components depicted as being stored in the data storage 620 may support functionality described in reference to corresponding components named earlier in this disclosure.

The data storage 620 may further store various types of data utilized by the components of the computing device(s) 600. Any data stored in the data storage 620 may be loaded into the memory 604 for use by the processor(s) 602 in executing computer-executable code. In addition, any data depicted as being stored in the data storage 620 may potentially be stored in one or more datastore(s) and may be accessed via the DBMS 624 and loaded in the memory 604 for use by the processor(s) 602 in executing computer-executable code. The datastore(s) may include, but are not limited to, databases (e.g., relational, object-oriented, etc.), file systems, flat files, distributed datastores in which data is stored on more than one node of a computer network, peer-to-peer network datastores, or the like.

The processor(s) 602 may be configured to access the memory 604 and execute the computer-executable instructions loaded therein. For example, the processor(s) 602 may be configured to execute the computer-executable instructions of the various program module(s), applications, engines, or the like of the computing device(s) 600 to cause or facilitate various operations to be performed in accordance with one or more embodiments of the disclosure. The processor(s) 602 may include any suitable processing unit capable of accepting data as input, processing the input data in accordance with stored computer-executable instructions, and generating output data. The processor(s) 602 may include any type of suitable processing unit including, but not limited to, a central processing unit, a microprocessor, a reduced instruction set computer (RISC) microprocessor, a complex instruction set computer (CISC) microprocessor, a microcontroller, an application-specific integrated circuit (ASIC), a field-programmable gate array (FPGA), a system-on-a-chip (SoC), a digital signal processor (DSP), and so forth. Further, the processor(s) 602 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor(s) 602 may be capable of supporting any of a variety of instruction sets.

Referring now to functionality supported by the various program module(s) depicted in FIG. 6, the module(s) 626 may include computer-executable instructions, code, or the like that responsive to execution by one or more of the processor(s) 602 may perform functions including, but not limited to, dynamically adjusting the number of valves that are opened and/or closed in a cascaded arrangement of water heaters, among other functionality described herein.

Referring now to other illustrative components depicted as being stored in the data storage 620, the O/S 622 may be loaded from the data storage 620 into the memory 604 and may provide an interface between other application software executing on the computing device(s) 600 and the hardware resources of the computing device(s) 600. More specifically, the O/S 622 may include a set of computer-executable instructions for managing hardware resources of the computing device(s) 600 and for providing common services to other application programs (e.g., managing memory allocation among various application programs). The O/S 622 may include any operating system now known or which may be developed in the future, including, but not limited to, any server operating system, any mainframe operating system, or any other proprietary or non-proprietary operating system.

The DBMS 624 may be loaded into the memory 604 and may support functionality for accessing, retrieving, storing, and/or manipulating data stored in the memory 604 and/or data stored in the data storage 620. The DBMS 624 may use any of a variety of database models (e.g., relational model, object model, etc.) and may support any of a variety of query languages. The DBMS 624 may access data represented in one or more data schemas and stored in any suitable data repository including, but not limited to, databases (e.g., relational, object-oriented, etc.), file systems, flat files, distributed datastores in which data is stored on more than one node of a computer network, peer-to-peer network datastores, or the like. In those example embodiments in which the computing device(s) 600 is a mobile device, the DBMS 624 may be any suitable lightweight DBMS optimized for performance on a mobile device.

Referring now to other illustrative components of the computing device(s) 600, the input/output (I/O) interface(s) 606 may facilitate the receipt of input information by the computing device(s) 600 from one or more I/O devices as well as the output of information from the computing device(s) 600 to one or more I/O devices. The I/O devices may include any of a variety of components such as a display or display screen having a touch surface or touchscreen; an audio output device for producing sound, such as a speaker; an audio capture device, such as a microphone; an image and/or video capture device, such as a camera; a haptic unit; and so forth. Any of these components may be integrated into the computing device(s) 600 or may be separate. The I/O devices may further include, for example, any number of peripheral devices such as data storage devices, printing devices, and so forth.

The I/O interface(s) 606 may also include an interface for an external peripheral device connection such as a universal serial bus (USB), Fire Wire, Thunderbolt, Ethernet port or other connection protocol that may connect to one or more networks. The I/O interface(s) 606 may also include a connection to one or more of the antenna(s) 634 to connect to one or more networks via a wireless local area network (WLAN) (such as Wi-Fi) radio, Bluetooth, ZigBee, and/or a wireless network radio, such as a radio capable of communication with a wireless communication network such as a Long Term Evolution (LTE) network, WiMAX network, 3G network, etc.

The computing device(s) 600 may further include one or more network interface(s) 608 via which the computing device(s) 600 may communicate with any of a variety of other systems, platforms, networks, devices, and so forth. The network interface(s) 608 may enable communication, for example, with one or more wireless routers, one or more host servers, one or more web servers, and the like via one or more networks.

The antenna(s) 634 may include any suitable type of antenna depending, for example, on the communications protocols used to transmit or receive signals via the antenna(s) 634. Non-limiting examples of suitable antennas may include directional antennas, non-directional antennas, dipole antennas, folded dipole antennas, patch antennas, multiple-input multiple-output (MIMO) antennas, or the like. The antenna(s) 634 may be communicatively coupled to one or more transceivers 612 or radio components to which or from which signals may be transmitted or received.

As previously described, the antenna(s) 634 may include a cellular antenna configured to transmit or receive signals in accordance with established standards and protocols, such as Global System for Mobile Communications (GSM), 3G standards (e.g., Universal Mobile Telecommunications System (UMTS), Wideband Code Division Multiple Access (W-CDMA), CDMA2000, etc.), 4G standards (e.g., LTE, WiMax, etc.), direct satellite communications, or the like.

The antenna(s) 634 may additionally, or alternatively, include a Wi-Fi antenna configured to transmit or receive signals in accordance with established standards and protocols, such as the IEEE 802.11 family of standards, including via 2.4 GHz channels (e.g., 802.11b, 802.11g, 802.11n), 5 GHz channels (e.g., 802.11n, 802.11ac), or 60 GHz channels (e.g., 802.11ad). In alternative example embodiments, the antenna(s) 634 may be configured to transmit or receive radio frequency signals within any suitable frequency range forming part of the unlicensed portion of the radio spectrum.

The antenna(s) 634 may additionally, or alternatively, include a GNSS antenna configured to receive GNSS signals from three or more GNSS satellites carrying time-position information to triangulate a position therefrom. Such a GNSS antenna may be configured to receive GNSS signals from any current or planned GNSS such as, for example, the Global Positioning System (GPS), the GLONASS System, the Compass Navigation System, the Galileo System, or the Indian Regional Navigational System.

The transceiver(s) 612 may include any suitable radio component(s) for—in cooperation with the antenna(s) 634—transmitting or receiving radio frequency (RF) signals in the bandwidth and/or channels corresponding to the communications protocols utilized by the computing device(s) 600 to communicate with other devices. The transceiver(s) 612 may include hardware, software, and/or firmware for modulating, transmitting, or receiving-potentially in cooperation with any of antenna(s) 634—communications signals according to any of the communications protocols discussed above including, but not limited to, one or more Wi-Fi and/or Wi-Fi direct protocols, as standardized by the IEEE 802.11 standards, one or more non-Wi-Fi protocols, or one or more cellular communications protocols or standards. The transceiver(s) 612 may further include hardware, firmware, or software for receiving GNSS signals. The transceiver(s) 612 may include any known receiver and baseband suitable for communicating via the communications protocols utilized by the computing device(s) 600. The transceiver(s) 612 may further include a low noise amplifier (LNA), additional signal amplifiers, an analog-to-digital (A/D) converter, one or more buffers, a digital baseband, or the like.

The sensor(s)/sensor interface(s) 610 may include or may be capable of interfacing with any suitable type of sensing device such as, for example, temperature sensors, humidity sensors, and so forth.

The speaker(s) 614 may be any device configured to generate audible sound. The microphone(s) 616 may be any device configured to receive analog sound input or voice data.

It should be appreciated that the program module(s), applications, computer-executable instructions, code, or the like depicted in FIG. 6 as being stored in the data storage 620 are merely illustrative and not exhaustive and that processing described as being supported by any particular module may alternatively be distributed across multiple module(s) or performed by a different module. In addition, various program module(s), script(s), plug-in(s), application programming interface(s) (API(s)), or any other suitable computer-executable code hosted locally on the computing device(s) 600, and/or hosted on other computing device(s) accessible via one or more networks, may be provided to support functionality provided by the program module(s), applications, or computer-executable code depicted in FIG. 6 and/or additional or alternate functionality. Further, functionality may be modularized differently such that processing described as being supported collectively by the collection of program module(s) depicted in FIG. 6 may be performed by a fewer or greater number of module(s), or functionality described as being supported by any particular module may be supported, at least in part, by another module. In addition, program module(s) that support the functionality described herein may form part of one or more applications executable across any number of systems or devices in accordance with any suitable computing model such as, for example, a client-server model, a peer-to-peer model, and so forth. In addition, any of the functionality described as being supported by any of the program module(s) depicted in FIG. 6 may be implemented, at least partially, in hardware and/or firmware across any number of devices.

It should further be appreciated that the computing device(s) 600 may include alternate and/or additional hardware, software, or firmware components beyond those described or depicted without departing from the scope of the disclosure. More particularly, it should be appreciated that software, firmware, or hardware components depicted as forming part of the computing device(s) 600 are merely illustrative and that some components may not be present or additional components may be provided in various embodiments. While various illustrative program module(s) have been depicted and described as software module(s) stored in the data storage 620, it should be appreciated that functionality described as being supported by the program module(s) may be enabled by any combination of hardware, software, and/or firmware. It should further be appreciated that each of the above-mentioned module(s) may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other module(s). Further, one or more depicted module(s) may not be present in certain embodiments, while in other embodiments, additional module(s) not depicted may be present and may support at least a portion of the described functionality and/or additional functionality. Moreover, while certain module(s) may be depicted and described as sub-module(s) of another module, in certain embodiments, such module(s) may be provided as independent module(s) or as sub-module(s) of other module(s).

One or more operations of the methods, process flows, and use cases of FIGS. 1-6 may be performed by a device having the illustrative configuration depicted in FIG. 6, or more specifically, by one or more engines, program module(s), applications, or the like executable on such a device. It should be appreciated, however, that such operations may be implemented in connection with numerous other device configurations.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Certain aspects of the disclosure are described above with reference to block and flow diagrams of systems, methods, apparatuses, and/or computer program products according to example embodiments. It will be understood that one or more blocks of the block diagrams and flow diagrams, and combinations of blocks in the block diagrams and the flow diagrams, respectively, may be implemented by execution of computer-executable program instructions. Likewise, some blocks of the block diagrams and flow diagrams may not necessarily need to be performed in the order presented, or may not necessarily need to be performed at all, according to some embodiments. Further, additional components and/or operations beyond those depicted in blocks of the block and/or flow diagrams may be present in certain embodiments.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Program module(s), applications, or the like disclosed herein may include one or more software components, including, for example, software objects, methods, data structures, or the like. Each such software component may include computer-executable instructions that, responsive to execution, cause at least a portion of the functionality described herein (e.g., one or more operations of the illustrative methods described herein) to be performed.

A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform.

Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, or a report writing language. In one or more example embodiments, a software component comprising instructions in one of the foregoing examples of programming languages may be executed directly by an operating system or other software component without having to be first transformed into another form.

A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

Software components may invoke or be invoked by other software components through any of a wide variety of mechanisms. Invoked or invoking software components may comprise other custom-developed application software, operating system functionality (e.g., device drivers, data storage (e.g., file management) routines, other common routines, and services, etc.), or third-party software components (e.g., middleware, encryption, or other security software, database management software, file transfer or other network communication software, mathematical or statistical software, image processing software, and format translation software).

Software components associated with a particular solution or system may reside and be executed on a single platform or may be distributed across multiple platforms. The multiple platforms may be associated with more than one hardware vendor, underlying chip technology, or operating system. Furthermore, software components associated with a particular solution or system may be initially written in one or more programming languages, but may invoke software components written in another programming language.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a CRSM that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Additional types of CRSM that may be present in any of the devices described herein may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the information and which can be accessed. Combinations of any of the above are also included within the scope of CRSM. Alternatively, computer-readable communication media (CRCM) may include computer-readable instructions, program module(s), or other data transmitted within a data signal, such as a carrier wave, or other transmission. However, as used herein, CRSM does not include CRCM.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

That which is claimed is:

1. A method for authenticating a first party in a transaction with a second party, the method comprising:
receiving, by one or more computer processors coupled to memory, a first request from the first party, wherein the first request is for a first payment from the second party to the first party;
determining a number of successful payment transactions associated with the first party over a time interval;
determining, using the number of successful payment transactions and the completeness metric, an authentication score for the first party; and
initiating, based at least in part on the authentication score, the first payment to the first party.

2. The method of claim 1, wherein initiating the payment to the first party comprises:
initiating, based at least in part on the authentication score, the payment to the first party from a third party bank account.

3. The method of claim 2, wherein the third party bank account is obtained from the digital profile associated with the first party or a digital profile associated with the second party.

4. The method of claim 2, wherein the third party bank account is not associated with the digital profile of the first party.

5. The method of claim 1, further comprising:
receiving, by the one or more computer processors, a second request from the first party, wherein the second request is for a second payment from the second party to the first party;
determining that the authentication score fails to satisfy a threshold value;
sending, based on determining that the authentication score fails to satisfy a threshold value, a request for authentication to the first party; and
initiating, based on receiving an indication of authentication from the first party, the second payment to the first party.

6. The method of claim 1, further comprising:
determining that a contact number associated with the first party is valid.

7. The method of claim 1, further comprising:
determining that an average user feedback value associated with the first party is greater than a threshold.

8. A system for authenticating a first party in a transaction with a second party, the system comprising:
memory that stores computer-executable instructions; and
one or more processors configured to access the memory and execute the computer-executable instructions to:
receive a first request from the first party, wherein the first request is for a first payment from the second party to the first party;
determine a number of successful payment transactions associated with the first party over a time interval;
determine, using the number of successful payment transactions and the completeness metric, an authentication score for the first party; and
initiate, based at least in part on the authentication score, the first payment to the first party.

9. The system of claim 8, wherein initiating the payment to the first party comprises:
initiating, based at least in part on the authentication score, the payment to the first party from a third party bank account.

10. The system of claim 9, wherein the third party bank account is obtained from the digital profile associated with the first party or a digital profile associated with the second party.

11. The system of claim 8, wherein the one or more processors are further configured to execute the computer-executable instructions to:
receive a second request from the first party, wherein the second request is for a second payment from the second party to the first party;
determine that the authentication score fails to satisfy a threshold value;
send, based on determining that the authentication score fails to satisfy a threshold value, a request for authentication to the first party; and
initiate, based on receiving an indication of authentication from the first party, the second payment to the first party.

12. The system of claim 8, wherein the one or more processors are further configured to execute the computer-executable instructions to:
determining that a contact number associated with the first party is valid or determining that an average user feedback value associated with the first party is greater than a threshold.

13. A system for automated authentication for a payment from a first party to a second party comprising:
memory that stores computer-executable instructions; and
one or more processors configured to access the memory and execute the computer-executable instructions to:
receive identifying information for the first party, the identifying information for the first party including a financial institution of the first party;
generate a digital profile for the first party based on the identifying information for the first party;
receive identifying information for the second party, the identifying information for the first broker including a financial institution of the broker;
generate a digital profile for the second party based on the identifying information for the second party;
store the digital profile for the first party and the digital profile for the second party in a database;
receive, from the first party, a request to onboard with the broker to perform a first shipment for a seller;
automatically obtain the information associated with the first party from the database;
provide the information associated with the first party to the second party;
determine that the first shipment is completed at a delivery destination;
determine a payment amount; and
automatically initiate a payment for the first shipment from the financial institution of the broker to the financial institution of the first party.

14. The system of claim 1, wherein the first party is a shipment carrier and the second party is a shipment broker.

15. The system of claim 1, wherein the one or more processors are further configured to execute the computer-executable instructions to:
generate a first score for the broker; and
determine that the first score for the second party is greater than or equal to a threshold value, wherein automatically initiate the payment for the first shipment is based on the first score for the second party being greater than or equal to a threshold value.

16. The system of claim 1, wherein the one or more processors are further configured to execute the computer-executable instructions to:
generate a second score for a second broker; and
determine that the second score for the second broker is less than threshold value;
determine that a second shipment is complete;
send, based on determining that the second score for the second broker is less than the threshold value, a request for authorization for a payment for the first shipment instead of automatically performing the payment; and
initiate the payment for the first shipment based on receiving an authorization.

17. The system of claim 1, wherein determine that the first shipment is completed further comprises:
determine that a device of the first party is within a threshold distance of the delivery destination.

18. The system of claim 1, wherein the one or more processors are further configured to execute the computer-executable instructions to:
validate, prior to generating the digital profile, an identity of the first party using a second database.

19. The system of claim 1, wherein the one or more processors are further configured to execute the computer-executable instructions to:
generate a token associated with the broker;
send the token to a device of the first party;
receive, from a third party merchant, a request for payment based on the token; and
send payment from the financial institution of the broker to the third party merchant.

20. The system of claim 1, wherein the one or more processors are further configured to execute the computer-executable instructions to:
present, via a user interface, at least some of the identifying information for the first party and the identifying information for the second party.
